(19) United States
(12) Patent Application Publication
(10) Pub. No.: US 2014/0380491 A1
(43) Pub. Date: Dec. 25, 2014

(54) ENDPOINT SECURITY IMPLEMENTATION

(71) Applicant: International Business Machines Corporation, Armonk, NY (US)

(72) Inventors: Tamer E. Abuelsaad, Somers, NY (US); Steven Charles Lingafelt, Research Triangle Park, NC (US)

(21) Appl. No.: 13/924,942

(22) Filed: Jun. 24, 2013

(51) Int. Cl. G06F 21/60

(52) U.S. Cl. CPC G06F 21/60
USPC 726/26

(57) ABSTRACT

A method includes a computer detecting an element from a data flow for at least one endpoint device; the computer using the detected element and a protection engine to assess security requirements for the flow of data for the at least one endpoint device; and the computer causing the protection engine to issue additional security controls for the at least one endpoint device.

### BACKGROUND

The present invention relates to endpoint security implementation and more specifically, to modifying endpoint security based upon data flow and security requirements for the data content.

### SUMMARY

According to one aspect of the present invention, a method includes a computer detecting an element from a data flow for at least one endpoint device; the computer using the detected element and a protection engine to assess security requirements for the flow of data for the at least one endpoint device; and the computer causing the protection engine to issue additional security controls for the at least one endpoint device.

According to another aspect of the present invention, a computer system includes one or more processors, one or more computer-readable memories and one or more computer-readable, tangible storage devices; a protection engine, operatively coupled to at least one of the one or more storage devices for execution by at least one of the one or more processors via at least one of the one or more memories, configured to receive an element from a data flow for at least one endpoint device; the protection engine, operatively coupled to at least one of the one or more storage devices for execution by at least one of the one or more processors via at least one of the one or more memories, being further configured to determine security requirements for the flow of data for the at least one endpoint device based upon the received element; and the protection engine, operatively coupled to at least one of the one or more storage devices for execution by at least one of the one or more processors via at least one of the one or more memories, being yet further configured to issue additional security controls for the at least one endpoint device.

According to yet another of the present invention, a computer program product includes one or more computer-readable, tangible storage medium; program instructions, stored on at least one of the one or more storage medium, to detect an element from a data flow for at least one endpoint device; program instructions, stored on at least one of the one or more storage medium, using the detected element and a protection engine to assess security requirements for the data flow; and program instructions, stored on at least one of the one or more storage medium, causing the protection engine to issue additional security controls for the at least one endpoint device.

### BRIEF DESCRIPTION OF THE SEVERAL VIEWS OF THE DRAWINGS

FIG. 1 shows a flow chart according to an embodiment of the present invention.

FIG. 2 illustrates an exemplary implementation according to an embodiment of the present invention.

FIG. 3 illustrates another exemplary implementation according to an embodiment of the present invention.

FIG. 4 illustrates yet another exemplary implementation according to an embodiment of the present invention.

FIG. 5 illustrates still another exemplary implementation according to an embodiment of the present invention.

FIG. 6 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

Within a compute environment, one can classify information based and determine the information's security classification, as defined by the enterprise business rules. For example, in a computer network it is possible to attach data classification sensors. The job of the sensors is to detect certain classes of data, for example, business sensitive data. Typically, devices with highly sensitive data require higher levels of security protections. However, a device might not have contained sensitive data at its time of inception, which resulted in a lower grade of security protection. With embodiments of the present invention systems are able to identify the need for higher security protections on a given device due to the flow of sensitive (or other classes) data to or from the device.

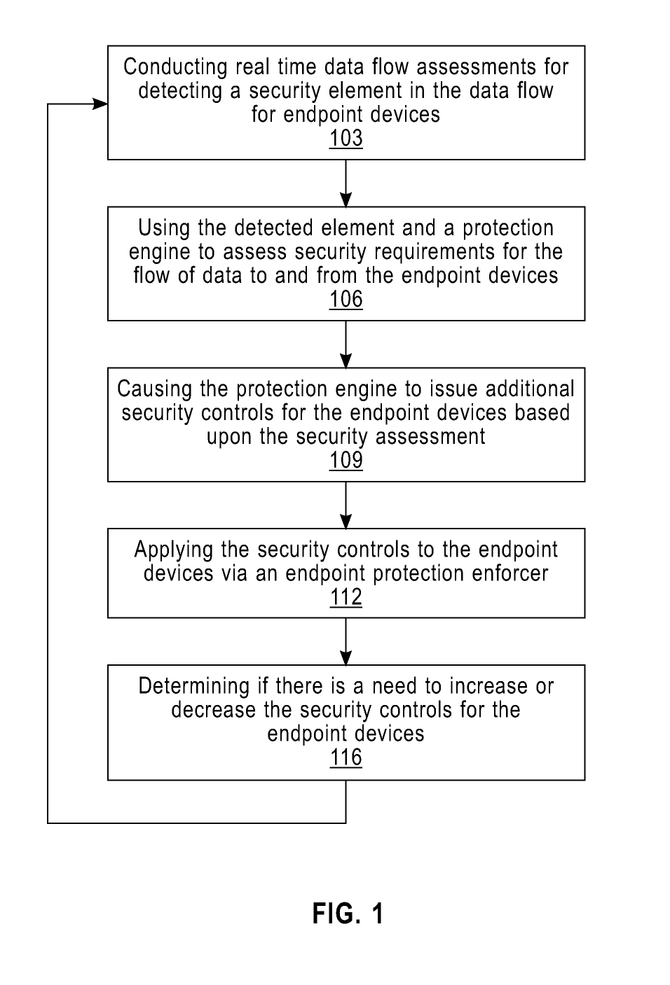

With reference now to FIG. 1, a flow chart according to an embodiment of the present invention is depicted. The process includes conducting real time data flow assessments for detecting a security element in the data flow for endpoint devices (103). As will be further described with reference to later embodiments, the security element may include references to International Traffic in Arms Regulations (ITAR). The ITAR references may include but are not limited to IP addresses, security business rules, system security postures or device inventory. The process uses the detected security element and a protection engine to assess the security requirements for the flow of data to and from the endpoint devices (106). Based upon the security assessment the protection engine issues additional security controls for the endpoint devices (109). It then becomes necessary to apply the security controls to the endpoint devices via an endpoint protection enforcer (112). The process then determines if there is a need to increase or decrease the security controls for the endpoint devices (116).

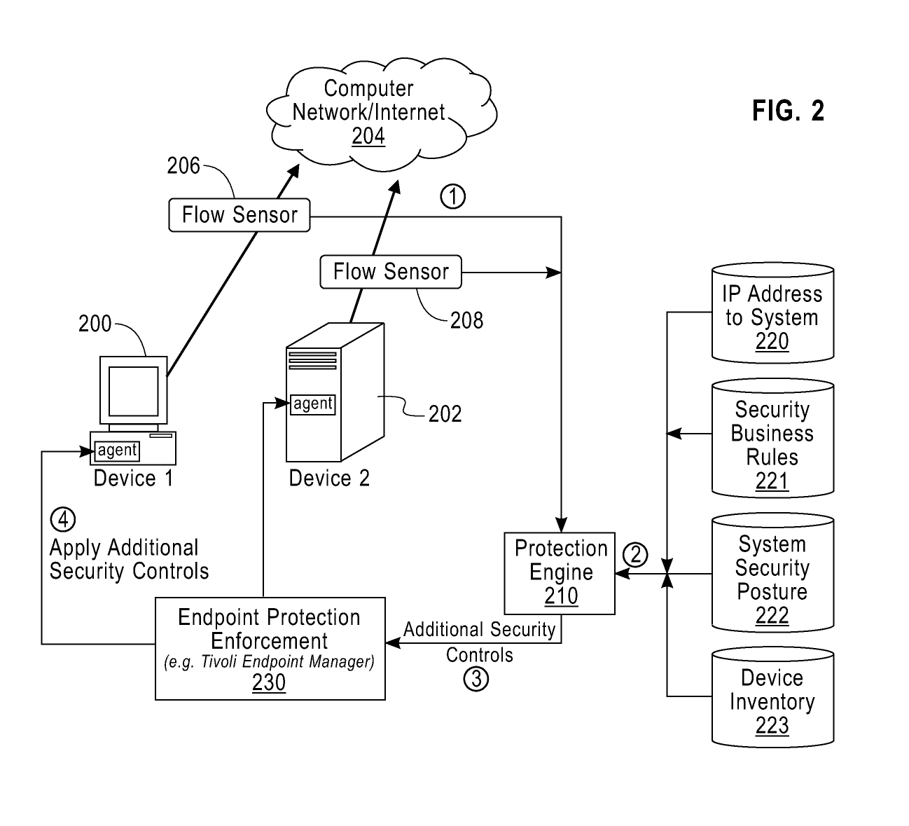

Referring to FIG. 2, shown is a network based exemplary implementation according to an embodiment of the present invention. Within a network, a sensor can observe network flows and classify the documents which are passing by it. An example of this classification technology is Fidelis' DLP (Data Loss Prevention) technology. One can then associate that network packet with an IP address. Once the IP address is determined then it is associated with a sending device. One can compare the security posture of the sending system (endpoint devices) to the enterprise's minimum required security posture for device's thereby continuing the maximum classification determined by the network sensor. If the device security posture is less than required by the enterprise, then force the endpoint device's security posture to the minimum specified by the enterprise.

More specifically, endpoint devices (200 and 202) send and receive data from the computer network/internet 204. This flow of data is monitored by flow sensors (206 and 208). The network flow sensors (206 and 208) observe the IP address of the packet, and determines the packet's security classification. This information is relayed to a protection engine 210. The protection engine 210 determines if additional security controls are required, based on information from various databases. The databases can include, but are not limited to, an IP address to system database 220, a security business rules database 221, a system security posture database 222 and a device inventory database 223. The IP address to system database 220 provides the identity of the endpoint devices (200 and 202). Once the identity of the endpoint devices (200 and 202) are determined, the protection engine 210 obtains the current system security posture from the system security posture database 221. The system security posture includes determining the endpoint devices (200 and 202) configuration. Based upon the packet's security classification, the protection engine 210 determines the minimum security control settings of the endpoint devices (200 and 202) as required by the Security Business Rules database 221. If the current system security controls posture is less than a minimum security control settings then the protection engine 210 determines that additional security controls are needed. When addition security controls are needed, as determined by the protection engine 210, the protection engine 210 uses information from the device inventory data 223. Once the required device information is obtained from the device inventory database 223, an endpoint protection enforcement manager 230 ensures that the additional security controls are applied to the endpoints (200 and 202). If the endpoint enforcement manger 230 fails to successfully apply the additional security controls to the endpoint devices (200 and 202) then an alert can be sent to an enterprise network administrator.

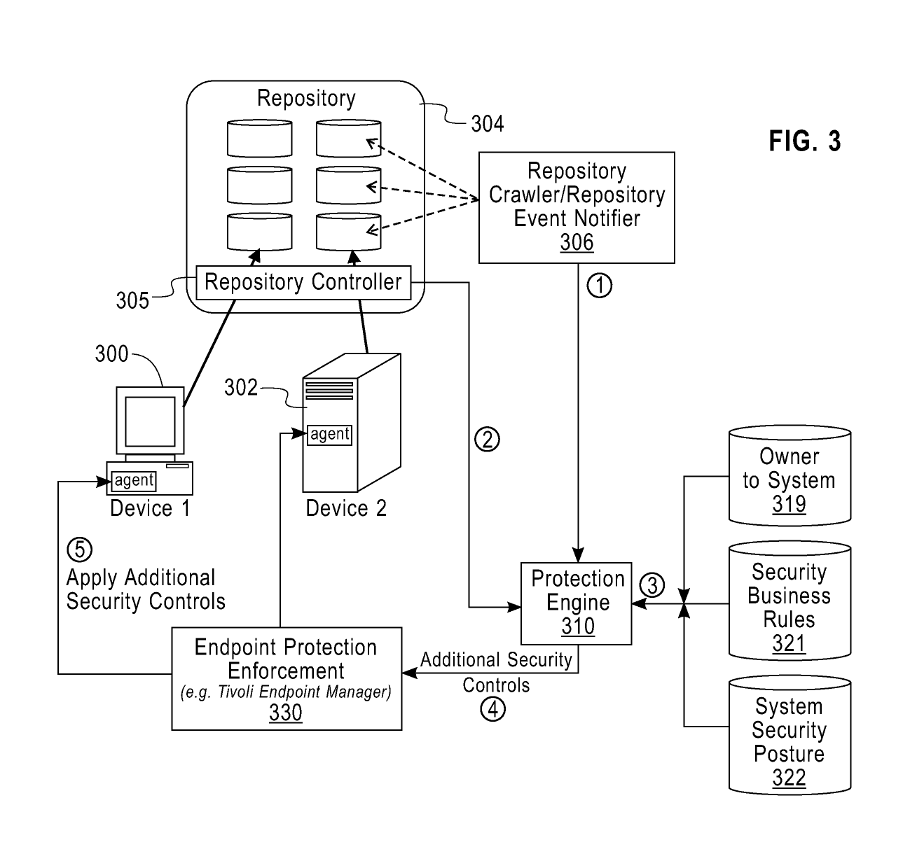

Referring to FIG. 3, shown is a repository based exemplary implementation according to an embodiment of the present invention. Within a repository a document crawler inspects documents and classifies the documents in the repository. One can then associate that classification with the owner of the document. Then associate the owner of the document with the owner's system that sourced the document. A security posture of the owner's system is compared to the enterprise's minimum required security posture for device's continuing the maximum classification determined by the crawler. If the device security posture is less than required by the enterprise, force the device's security posture to the minimum specified by the enterprise.

More specifically, endpoint devices (300 and 302) send and receive data from a repository 304. A repository crawler 306 inspects repository files, observing the ID of the file and determines the file's security classification. A repository controller system 305 determines the owner of the file. The information from the crawler 306 and the controller 305 are relayed to a protection engine 310. The protection engine 310 determines if additional security controls are required, based on information from various databases. The databases can include, but are not limited to, an owner to system database 319, a security business rules database 321, and a system security posture database 322. The owner to system database 319 provides the identity of the endpoint devices (300 and 302). Once the identity of the endpoint devices (300 and 302) are determined, the protection engine 310 obtains the current system security posture from the system security posture database 321. The system security posture includes determining the endpoint devices (300 and 302) configuration. Based upon the packet's security classification, the protection engine 310 determines the minimum security control settings of the endpoint devices (300 and 302) as required by the Security Business Rules database 321. If the current system security controls posture is less than a minimum security control settings then the protection engine 310 determines that additional security controls are needed. When addition security controls are needed, as determined by the protection engine 310, an endpoint protection enforcement manager 330 ensures that the additional security controls are applied to the endpoints (300 and 302). If the endpoint enforcement manger 330 fails to successfully apply the additional security controls to the endpoint devices (300 and 302) then an alert can be sent to an enterprise network administrator.

It is to be appreciated that the Repository Controller 305 can perform the classification (or retrieval of classification from a cache) task upon file download/upload request. In this case, upon certain operations, such as file download, the Repository Controller 305 communicates the file classification (maybe other file meta data) and the endpoint accessing it (downloading).

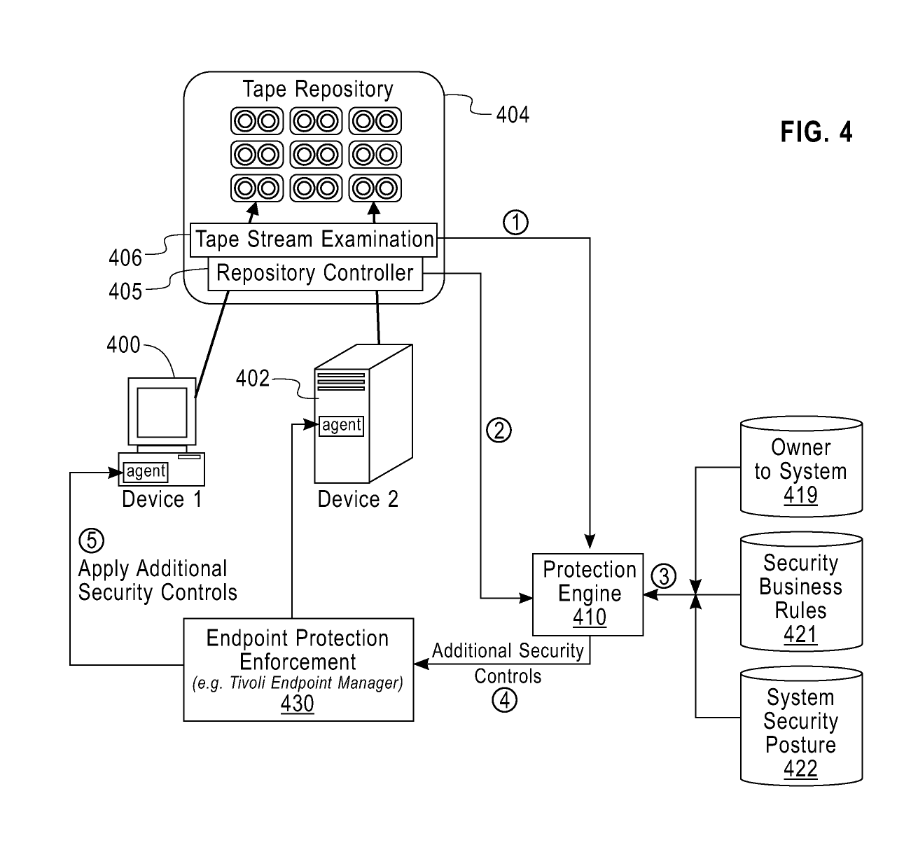

Referring to FIG. 4, shown is a tape repository backup/archive based exemplary implementation according to an embodiment of the present invention. Within a tape backup repository a tape stream examination crawler inspects documents and classifies the documents in the repository. One can then associate that classification with the backup/archive facility account owner which deposited the document into the infrastructure. Then associate the owner of the document with the owner's system that sourced the document. A security posture of the owner's system is compared to the enterprise's minimum required security posture for device's continuing the maximum classification determined by the crawler. If the device security posture is less than required by the enterprise, force the device's security posture to the minimum specified by the enterprise.

More specifically, endpoint devices (400 and 402) send and receive data from a tape backup repository 404. A tape stream examination unit 406 inspects the repository files, observing the ID of the file and determines the file's security classification. A library controller system 405 determines the owner of the file. The information from the tape stream examination unit 406 and the controller 405 are relayed to a protection engine 410. The protection engine 410 determines if additional security controls are required, based on information from various databases. The databases can include, but are not limited to, an owner to system database 419, a security business rules database 421, and a system security posture database 422. The owner to system database 419 provides the identity of the endpoint devices (400 and 402). Once the identity of the endpoint devices (400 and 402) are determined, the protection engine 410 obtains the current system security posture from the system security posture database 421. The system security posture includes determining the endpoint devices (400 and 402) configuration. Based upon the packet's security classification, the protection engine 410 determines the minimum security control settings of the endpoint devices (400 and 402) as required by the Security Business Rules database 421. If the current system security controls posture is less than a minimum security control settings then the protection engine 410 determines that additional security controls are needed. When addition security controls are needed, as determined by the protection engine 410, an endpoint protection enforcement manager 430 ensures that the additional security controls are applied to the endpoints (400 and 402). If the endpoint enforcement manger 430 fails to successfully apply the additional security controls to the endpoint devices (400 and 402) then an alert can be sent to an enterprise network administrator.

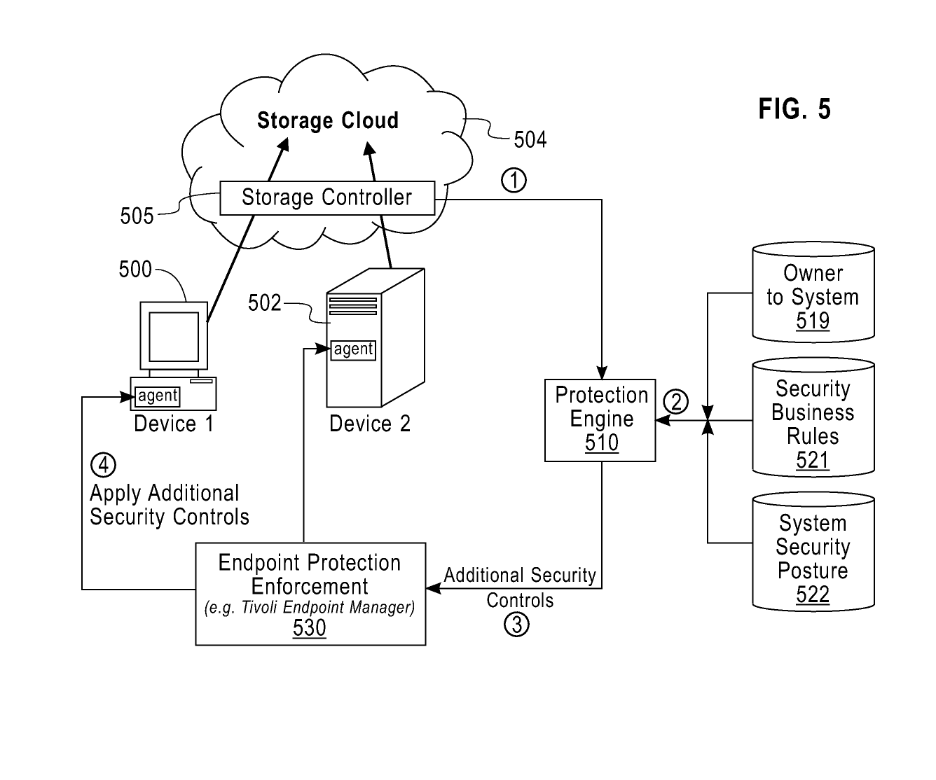

Referring to FIG. 5, shown is a storage cloud based exemplary implementation according to an embodiment of the present invention. Within a storage cloud a storage controller inspects documents and classifies the documents in the cloud. One can then associate that classification with the ID resourced file and the requesting device with its IP address. Then associate the owner of the document with the owner's system that requested the document. A security posture of the owner's system is compared to the enterprise's minimum required security posture for device's continuing the maximum classification determined by the crawler. If the device security posture is less than required by the enterprise, force the device's security posture to the minimum specified by the enterprise.

More specifically, endpoint devices (500 and 502) send and receive data from a storage cloud 504. A storage controller 505 inspects storage cloud content as part of any transactions, observes the ID of the resource file, determines the file's security classification, and IP or Network identifier of the requesting endpoint devices (500 and 502). The information from the storage controller 505 is relayed to a protection engine 510. The protection engine 510 determines if additional security controls are required, based on information from various databases. The databases can include, but are not limited to, an owner to system database 519, a security business rules database 521, and a system security posture database 522. The owner to system database 519 provides the identity of the endpoint devices (500 and 502). Once the identity of the endpoint devices (500 and 502) are determined, the protection engine 510 obtains the current system security posture from the system security posture database 521. The system security posture includes determining the endpoint devices (500 and 502) configuration. Based upon the packet's security classification, the protection engine 510 determines the minimum security control settings of the endpoint devices (500 and 502) as required by the Security Business Rules database 521. If the current system security controls posture is less than a minimum security control settings then the protection engine 510 determines that additional security controls are needed. When addition security controls are needed, as determined by the protection engine 510, an endpoint protection enforcement manager 530 ensures that the additional security controls are applied to the endpoints (500 and 502). If the endpoint enforcement manger 530 fails to successfully apply the additional security controls to the endpoint devices (500 and 502) then an alert can be sent to an enterprise network administrator. It can be appreciated that this exemplary embodiment can also be implemented with a storage cloud controller that resides outside the storage cloud.

It is further noted that for each of the embodiments of the present invention, examples of additional security controls may include, but limited thereto, endpoint storage encryption, multi-factor authentication to gain access the endpoint, stronger password, specific certification for endpoint users, and many others.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

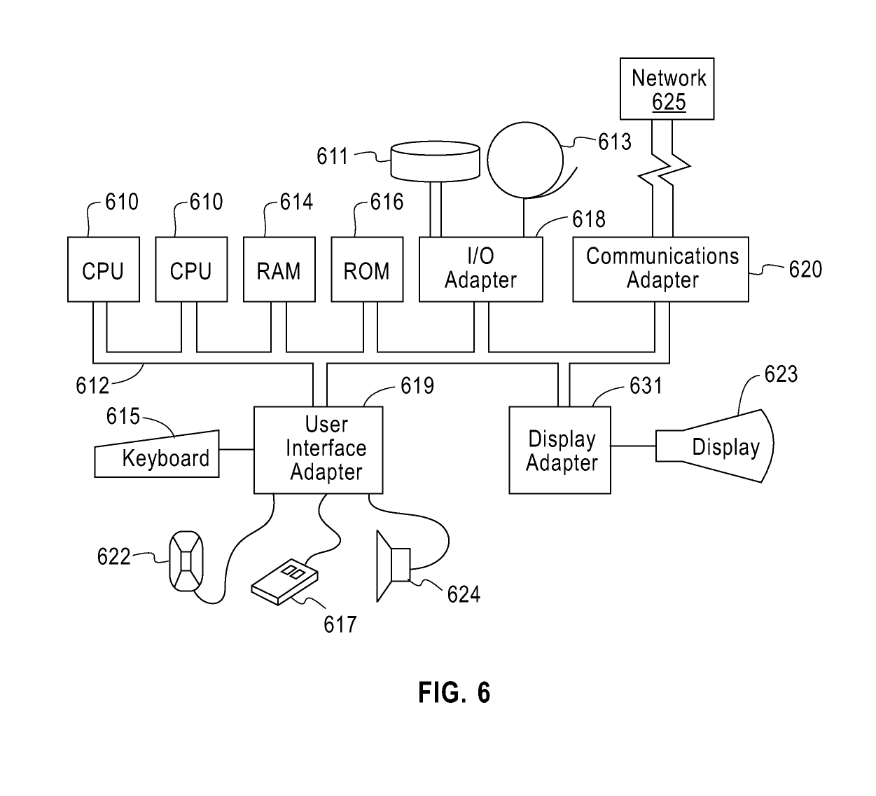

Referring now to FIG. 6, this schematic drawing illustrates a hardware configuration of an information handling/computer system in accordance with the embodiments of the invention. The system comprises at least one processor or central processing unit (CPU) 610. The CPUs 610 are interconnected via system bus 612 to various devices such as a random access memory (RAM) 614, read-only memory (ROM) 616, and an input/output (I/O) adapter 618. The I/O adapter 618 can connect to peripheral devices, such as disk units 611 and tape drives 613, or other program storage devices that are readable by the system. The system can read the inventive instructions on the program storage devices and follow these instructions to execute the methodology of the embodiments of the invention. The system further includes a user interface adapter 619 that connects a keyboard 615, mouse 617, speaker 624, microphone 622, and/or other user interface devices such as a touch screen device (not shown) to the bus 612 to gather user input. Additionally, a communication adapter 620 connects the bus 612 to a data processing network 625, and a display adapter 621 connects the bus 612 to a display device 623 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a computer detecting an element from a data flow for at least one endpoint device;
the computer using the detected element and a protection engine to assess security requirements for the flow of data for the at least one endpoint device; and
the computer causing the protection engine to issue additional security controls for the at least one endpoint device.

2. The method of claim 1, wherein the data flow is being transmitted from the at least one endpoint device to a computer network.

3. The method of claim 1, wherein the data flow is received by the at least one endpoint device from a computer network.

4. The method of claim 1, wherein the protection engine uses data from an IP address database to determine the security controls.

5. The method of claim 1, wherein the protection engine uses data from a security business rules database to determine the security controls.

6. The method of claim 1, wherein the protection engine uses data from a system security posture database to determine the security controls.

7. The method of claim 1, wherein the data flow is between a storage device and the at least one endpoint device.

8. The method of claim 7, wherein the protection engine uses data from an owner database to determine the security controls.

9. A computer system comprising:
one or more processors, one or more computer-readable memories and one or more computer-readable, tangible storage devices;
a protection engine, operatively coupled to at least one of the one or more storage devices for execution by at least one of the one or more processors via at least one of the one or more memories, configured to receive an element from a data flow for at least one endpoint device;
the protection engine, operatively coupled to at least one of the one or more storage devices for execution by at least one of the one or more processors via at least one of the one or more memories, being further configured to determine security requirements for the flow of data for the at least one endpoint device based upon the received element; and
the protection engine, operatively coupled to at least one of the one or more storage devices for execution by at least one of the one or more processors via at least one of the one or more memories, being yet further configured to issue additional security controls for the at least one endpoint device.

10. The system according to claim 9, wherein the protection engine uses data from an IP address database as part of the determination for the security requirements for the data flow.

11. The system according to claim 9, wherein the protection engine uses data from a security business rules database as part of the determination for the security requirements for the data flow.

12. The system according to claim 9, wherein the protection engine uses data from a system security posture database as part of the determination for the security requirements for the data flow.

13. The system according to claim 9, wherein the data flow is between a computer network and the at least one endpoint device.

14. The system according to claim 9, wherein the data flow is between a storage device and the at least one endpoint device.

15. The system according to claim 14, wherein the protection engine uses data from an owner database as part of the determination for the security requirements for the data flow.

16. A computer program product comprising:
one or more computer-readable, tangible storage medium;
program instructions, stored on at least one of the one or more storage medium, to detect an element from a data flow for at least one endpoint device;
program instructions, stored on at least one of the one or more storage medium, using the detected element and a protection engine to assess security requirements for the data flow; and
program instructions, stored on at least one of the one or more storage medium, causing the protection engine to issue additional security controls for the at least one endpoint device.

17. The computer program product according to claim 16, wherein the protection engine uses data from an IP address database to determine the security controls.

18. The computer program product according to claim 16, wherein the protection engine uses data from a security business rules database to determine the security controls.

19. The computer program product according to claim 16, wherein the protection engine uses data from a system security posture database to determine the security controls.

20. The computer program product according to claim 16, wherein the data flow is between a storage device and the at least one endpoint device.
